(19) United States
(12) Patent Application Publication
(10) Pub. No.: US 2007/0153337 A1
(43) Pub. Date: Jul. 5, 2007

(54) Image sensor and method of fabricating the same

(75) Inventor: Ki-hong Kim, Yongin-si (KR)

Correspondence Address: HARNESS, DICKEY & PIERCE, P.L.C., P.O. BOX 8910, RESTON, VA, 20195, US

(73) Assignee: Samsung Electronics Co. Ltd.

(21) Appl. No.: 11/648,661

(22) Filed: Jan. 3, 2007

(30) Foreign Application Priority Data
Jan. 3, 2006 (KR) 10-2006-0000655

(51) Int. Cl. H04N 1/04

(52) U.S. Cl. 358/482; 358/513

(57) ABSTRACT

An example embodiment is directed to an image sensor including a photoelectric transformation unit, an opening formed above the photoelectric transformation unit, and a barrier layer on a side surface of the opening to prevent or reduce crosstalk. The photoelectric transformation unit may be in a semiconductor substrate, and an interlayer insulating layer may cover a surface of the semiconductor substrate. A light transmission unit may fill the opening, and a color filter and a micro-lens on the color filter may be on top of the light transmission unit.

### PRIORITY STATEMENT

This application claims priority from Korean Patent Application No. 10-2006-000655 filed on Jan. 3, 2006 in the Korean Intellectual Property Office, the disclosure of which is incorporated herein by reference in its entirety.

### BACKGROUND

1. Field

Example embodiments relate to an image sensor and a method of fabricating the same.

2. Description of the Related Art

Image sensors are devices for converting optical images into electrical signals. Recently, with the advancements made in computers and in communication industries, demand for image sensors with improved performance has increased in various technical fields, for example, digital cameras, camcorders, Personal Communication Systems (PCSs), game machines, security cameras, medical micro-cameras, and robotics.

A unit pixel of an image sensor performs photoelectric transformation on incident light, accumulates charge corresponding to the amount of light in its photoelectric transformation unit, and reproduces an image signal through a read-out operation. However, incident light may influence an adjacent unit without accumulating in a photoelectric transformation unit of a target unit pixel on which the light is incident. For example, in the case of a Charge Coupled Device (CCD), charge generated on the lower portion and side portion of a photodiode may be injected into a vertical transfer CCD channel, so that a smearing phenomenon may occur. Further, in the case of a Complementary Metal Oxide Semiconductor (CMOS) image sensor, generated charge may be moved to and accumulated in a photoelectric transformation unit of an adjacent pixel, so that pixel crosstalk may result.

Pixel crosstalk may be defined as a phenomenon in which charge is transferred to a photoelectric transformation unit of a unit pixel adjacent to a target unit pixel, not the target unit pixel, by refracted light that is formed when light incident through a micro-lens and/or a color filter is refracted from a multi-layer structure composed of interlayer insulating layers having different refractive indices and/or from a surface of a non-uniform film, and/or by reflected light that is formed when the incident light is reflected from the top surface or side surface of a metallic wire.

If crosstalk occurs, resolution may be deteriorated in a monochrome image sensor, thereby causing image distortion. Further, in the case of a color image sensor using a Color Filter Array (CFA) specific to red, green and blue, there is a probability that crosstalk from incident red light having long wavelengths will occur, so that tint quality may be inferior. Further, a blooming phenomenon, in which adjacent pixels on a screen are dim and/or blurry, may also occur.

### SUMMARY

Accordingly, example embodiments provide an image sensor that may decrease pixel crosstalk. Other example embodiments provide a method of fabricating an image sensor that may decrease or prevent pixel crosstalk.

An example embodiment is directed to an image sensor including a photoelectric transformation unit, an opening formed above the photoelectric transformation unit, and a barrier layer on a side surface of the opening to prevent or reduce crosstalk. The photoelectric transformation unit may be in a semiconductor substrate, and an interlayer insulating layer may cover a surface of the semiconductor substrate. A light transmission unit may fill the opening, and a color filter and a micro-lens on the color filter may be on top of the light transmission unit.

Another example embodiment is directed to a method of fabricating an image sensor, including forming a photoelectric transformation unit in a semiconductor substrate, forming an interlayer insulating layer to cover a surface of the semiconductor substrate, forming an interlayer insulating layer by alternately stacking inter-metal insulating layers and metallic wires on the interlayer insulating layer, forming an opening spaced apart from the metallic wire above the photoelectric transformation unit, extending the opening into the interlayer insulating layer through the inter-metal insulating layer, forming a barrier layer on a side surface of the opening to prevent or reduce crosstalk, forming a light transmission unit to fill the opening, forming a color filter on the light transmission unit, and forming a micro-lens on the color filter.

### BRIEF DESCRIPTION OF THE DRAWINGS

Features of the example embodiments and their advantages will be more clearly understood from the following detailed description taken in conjunction with the accompanying drawings, in which:

FIG. 1 is a block diagram showing an image sensor according to example embodiments;

FIG. 2 is a circuit diagram of a unit pixel of an image sensor according to an example embodiment;

FIG. 3 is a schematic plan view of a active pixel sensor array of an image sensor according to an example embodiment;

FIG. 4 is an example sectional view taken along line IV-IV′ of FIG. 3;

FIG. 5 is a flowchart of a method of fabricating an image sensor according to an example embodiment;

FIGS. 6 to 11 are sectional views showing a method of fabricating an image sensor according to a example embodiments; and

FIG. 12 is a schematic diagram of a process-based system including an image sensor according to an example embodiment.

### DETAILED DESCRIPTION OF THE EXAMPLE EMBODIMENTS

Various example embodiments will now be described more fully with reference to the accompanying drawings in which some example embodiments of the invention are shown. In the drawings, the thicknesses of layers and regions are exaggerated for clarity.

Detailed illustrative embodiments are disclosed herein. However, specific structural and functional details disclosed herein are merely representative for purposes of describing example embodiments. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like elements throughout the description of the figures.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “formed on” another element or layer, it can be directly or indirectly formed on the other element or layer. That is, for example, intervening elements or layers may be present. In contrast, when an element or layer is referred to as being “directly formed on” to another element, there are no intervening elements or layers present. Other words used to describe the relationship between elements or layers should be interpreted in a like fashion (e.g., “between” versus “directly between”, “adjacent” versus “directly adjacent”, etc.).

An image sensor according to example embodiments may include a Charge Coupled Device (CCD), a Complementary Metal Oxide Semiconductor (CMOS) image sensor, or other image sensing technology. A CCD may have less noise and excellent image quality compared to a CMOS image sensor, but it may require a higher voltage and may have higher manufacturing costs. A CMOS image sensor may have a simpler driving scheme and may be implemented using various scanning methods. A CMOS image sensor may be further advantageous in that, because signal processing circuits may be integrated into a single chip, products may reduced or be miniaturized, and because CMOS manufacturing process technology is compatible for use therewith, the costs of manufacturing a CMOS image sensor may be decreased. Further, a CMOS image sensor may have lower power consumption and may be more easily applied to products having limited battery capacity. A CMOS image sensor is described below as an example of an image sensor. Other example embodiments of the present invention may also include CCD and other image sensing technology.

It should also be noted that in some alternative embodiments, the functions/acts noted may occur out of the order noted in the FIGS. For example, two FIGS. shown in succession may in fact be executed substantially concurrently or may sometimes be executed in the reverse order, depending upon the functionality/acts involved.

Hereinafter, an image sensor according to example embodiments is described with reference to the attached drawings.

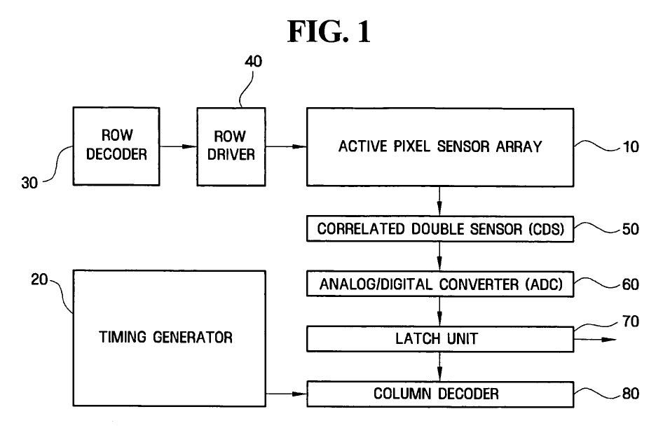

FIG. 1 is a block diagram of an image sensor according to example embodiments.

As shown in FIG. 1, an image sensor according to example embodiments may include an Active Pixel Sensor array (APS array) 10, a timing generator 20, a row decoder 30, a row driver 40, a Correlated Double Sampler (CDS) 50, an Analog to Digital Converter (ADC) 60, a latch unit 70, and/or a column decoder 80.

The APS array 10 may further include a plurality of unit pixels arranged in two dimensions. Unit pixels may function to convert optical images into electrical signals. The APS array 10 may receive a plurality of driving signals, for example, as a pixel selection signal ROW, a reset signal RST, a charge transfer signal TG, or the like, from the row driver 40, and may be driven by those signals. Further, the electrical signals may be provided to the correlated double sampler 50 through a vertical signal line.

The timing generator 20 may provide timing signals and control signals to the row decoder 30 and/or to the column decoder 80.

The row driver 40 may provide a plurality of driving signals that drive a plurality of unit pixels to the APS array 10, based on the results of decoding by the row decoder 30. When the unit pixels are arranged in the form of a matrix, driving signals may be provided for respective rows.

The correlated double sampler 50 may receive an electrical signal from the APS array 10 through the vertical signal line, and the correlated double sampler 50 may hold and/or sample the electrical signals. The correlated double sampler 50 may perform double sampling on a specific reference voltage level (hereinafter referred to as a ‘noise level’), and the voltage level of the formed electrical signal (hereinafter referred to as a ‘signal level’), and may output a difference level corresponding to the difference between the noise level and the signal level.

The ADC 60 may convert an analog signal, which may correspond to the difference level, into a digital signal, and may output the digital signal.

The latch unit 70 may latch the digital signal and sequentially output the latched signal to an image signal processing unit (not shown), depending on the results of decoding by the column decoder 80.

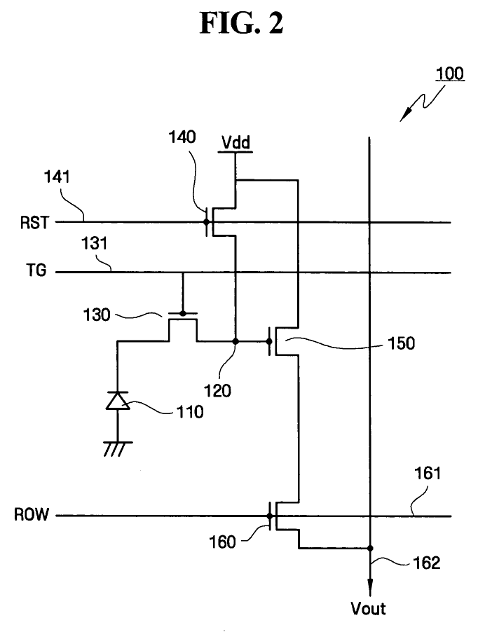

FIG. 2 is a circuit diagram of a unit pixel of an image sensor according to example embodiments.

As shown in FIG. 2, the unit pixel 100 of an image sensor according to the example embodiments may include a photoelectric transformation unit 110, a charge detection unit 120, a charge transfer unit 130, a reset unit 140, an amplification unit 150, and/or a selection unit 160. In example embodiments, a unit pixel 100 may include four or more transistors.

The photoelectric transformation unit 110 may absorb incident light and accumulate charge corresponding to the amount of light. The photoelectric transformation unit 110 may use a photodiode, a phototransistor, a photogate, a Pinned Photodiode (PPD), or the like, or any combination thereof.

The charge detection unit 120 may include a Floating Diffusion (FD) region and cumulatively store charge accumulated in the photoelectric transformation unit 110. charge The charge detection unit 120 may be electrically connected to the gate of the amplification unit 150 and may control the amplification unit 150.

The charge transfer unit 130 may transfer charge from the photoelectric transformation unit 110 to the charge detection unit 120. The charge transfer unit 130 may include one or more transistors and may be controlled by the charge transfer signal TG.

The reset unit 140 may periodically reset the charge detection unit 120. The reset unit 140 may supply charge to the charge detection unit 120, and the reset unit 140 may draw charge from a supply voltage Vdd. Further, the reset unit 140 may be driven in response to the reset signal RST.

The amplification unit 150 may function as a source follower buffer amplifier in combination with a constant current source (not shown) placed outside the unit pixel 100 and output a voltage, which may vary in response to a voltage of the charge detection unit 120, to a vertical signal line 162. A source of the amplification unit 150 may be connected to a drain of the selection unit 160, and the drain of the amplification unit 150 may be connected to the supply voltage Vdd.

The selection unit 160 may function to select a unit pixel 100 to be read out for each row. The selection unit 160 may be driven in response to a selection signal ROW, and a source thereof may be connected to the vertical signal line 162.

The driving signal lines 131, 141 and 161 for the charge transfer unit 130, the reset unit 140, and the selection unit 160 may extend in the direction of rows (horizontal direction) so that unit pixels included in a same row are simultaneously driven.

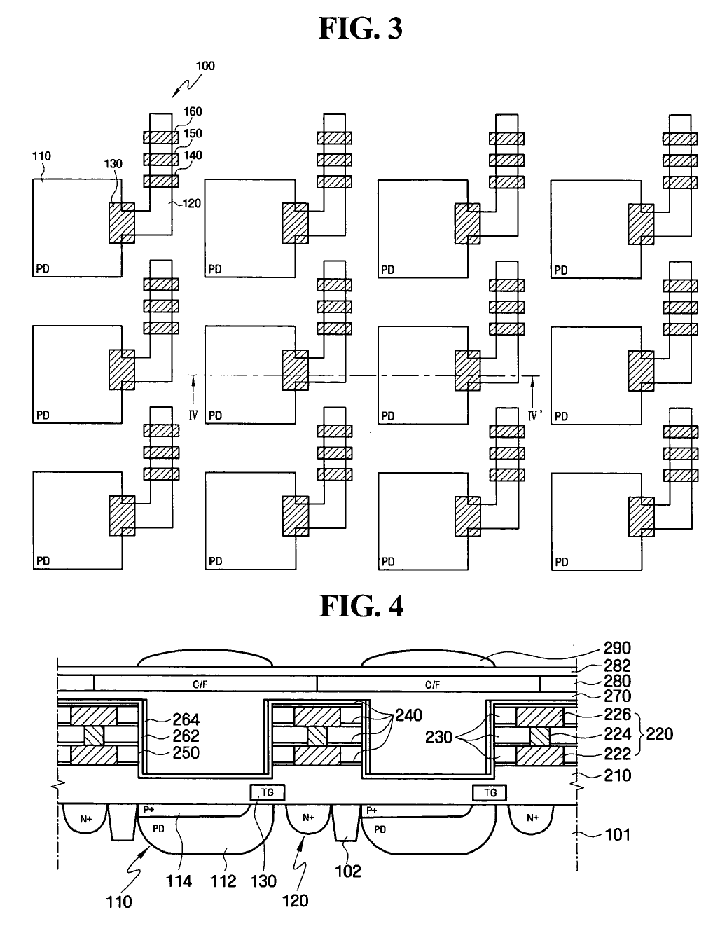

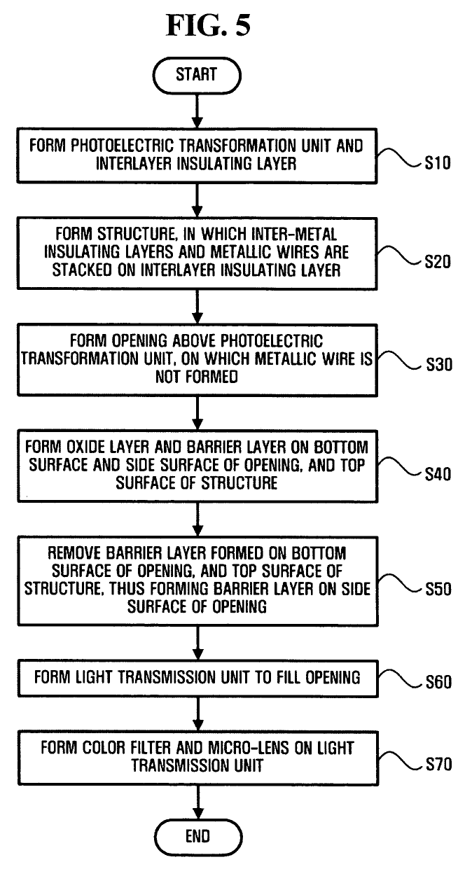

FIG. 3 is a schematic plan view of a active pixel sensor array of an image sensor according to an example embodiment. FIG. 4 is a sectional view taken along line IV-IV′ of FIG. 3.

As shown in FIGS. 3 and 4, an image sensor according to example embodiments may include photoelectric transformation units 110, charge detection units 120, and charge transfer units 130 that may be formed on a semiconductor substrate 101, structure 215 in which metallic wires 220 and inter-metal insulating layers 230 may be stacked in an alternating sequence, barrier layers 264, a light transmission unit 270, color filters 280, and/or micro-lenses 290.

Device isolation regions 102 on the semiconductor substrate 101 may define active regions. Each device isolation region 102 may be a Field Oxide (FOX) region, Shallow Trench Isolation (STI) region, or the like, which may be formed using LOCal Oxidation of Silicon (LOCOS).

The photoelectric transformation units 110 for absorbing light energy and accumulating generated charge may be formed on an active regions of the semiconductor substrate 101. Each of the photoelectric transformation units 110 may include an N type photodiode 112 and a P+ type pinning layer 114. In an image sensor, damage to a surface of the photodiode 112 may cause dark current. Such surface damage may be caused by dangling silicon bonds or defects related to etching stress occurring during a process of manufacturing gates or spacers. To potentially avoid these problems and more easily perform charge transfer, the photodiode 112 may be formed deeper in the semiconductor substrate 101, and the pinning layer 114 may be formed so that an occurrence of dark current is reduced or prevented.

The charge detection units 120, transistors corresponding to the charge transfer units 130, the reset units 140, the amplification units 150, and/or the selection units 160 may be formed on the semiconductor substrate 101.

An interlayer insulating layer 210 may be formed on both the photoelectric transformation units 110 and the charge transfer units 130 and may cover the semiconductor substrate 101 and/or fill an empty space in which no transistors are formed. The interlayer insulating layer 210 may be formed of a silicon oxide film or the like.

Structure 215 formed by alternating metallic wire 220 and inter-metal insulating layers 230 may be formed on the interlayer insulating layer 210. Each metallic wire 220 may include a single- or multi-layer structure. If the metallic wire 220 includes a multi-layer structure, the inter-metal insulating layers 230 may fill a space between an upper and lower metallic wires, and upper metallic wire 226 and lower metallic wire 222 may be connected to each other through a hole 224. In FIG. 4, an example of a multi-layer (for example, 2 layers) metallic wire 220 is shown.

Metallic wire 220 may include tungsten (W), copper (Cu), or any suitably-resistive material. The inter-metal insulating layers 230 may include Flowable Oxide (FOX), High Density Plasma (HDP), Tonen SilaZene (TOSZ), Spin On Glass (SOG), Undoped Silica Glass (USG), or any suitably-insulating material. Etching stopper films 240 may be formed between a plurality of inter-metal insulating layers 230, and may include, for example, Silicon Nitride (SiN) or the like.

Each metallic wire 220 may be formed anywhere in an APS array, except on the photoelectric transformation units 110. Openings 250 may be formed above the photoelectric transformation units 110. Each of the openings 250 may be formed to be spaced apart from the metallic wire 220 by a predetermined or desired distance and may extend into the interlayer insulating layer 210 through the inter-metal insulating layers 230. The opening 250 may be formed to prevent or reduce incident light refraction and reflection from inter-metal insulating layers 230 and the etching stopper films 240. This formation may prevent or reduce crosstalk and increase the transmissivity of incident light.

A barrier layer 264 may be provided on a side surface of the opening 250. The barrier layer 264 may reduce or prevent an occurrence of crosstalk due to incident light's transmission to a photoelectric transformation unit of an adjacent unit pixel, not a target unit pixel. The barrier layer 264 may include a material having a refractive index greater than that of the light transmission unit 270, which may fill the opening 250. For example, the barrier layer 264 may include silicon nitride, which has a refractive index greater than that of the light transmission unit 270 by 0.3 or more, or any similar material.

An oxide layer 262 may be formed on any surfaces of the opening 250 and on a top surface of the alternated inter-metal insulator 230 and metallic-wire structure 215. The barrier layer 264 may be formed on top of the oxide layer 262. The oxide layer 262 may be used as an etching stopper film in an etching process for forming the barrier layer 264 and may function to protect the bottom of the opening 250.

The light transmission unit 270 may fill the opening 250 and cover the top of the alternated inter-metal insulator and metallic-wire structure 215 so that a surface placed above the opening 250 and this structure are planarized. The light transmission unit 270 may include a transparent and light-permeable material, for example, thermosetting resin or the like. The light transmission unit 270 may be made of a material having a refractive index lower than that of the barrier layer 264.

Each of the color filters 280 may be formed on the light transmission unit 270. The color filters 280 may possess any light filtration arrangement to achieve desired light transmission properties. A color filter having individual red, green, and blue filters may be used as the color filter 280. The color filters 280 may possess a Bayer-type arrangement of color filters such that a green color filter, to which the human eye has the most sensitively, is arranged to occupy about half of the entire color filters 280.

Micro-lenses 290 may be formed on a portion of the color filter 280 corresponding to the photoelectric transformation unit 110. The micro-lens 290 may be formed using, for example, a TMR or MFR resin, or any similar material. The micro-lens 290 may change the path of light incident on a region other than the photoelectric transformation unit 110 and focus light on a region of the photoelectric transformation unit 110.

A planarizing layer 282 may be formed between the color filter 280 and the micro-lens 290, and can be made of, for example, thermosetting resin or any similar material. Light may pass through the micro-lens 290 and the color filter 280 and may be incident on the light transmission unit 270. Light incident on the light transmission unit 270 may be incident on the photoelectric transformation unit 110. In example embodiments, the micro-lens 290 may focus the incident light on the photoelectric transformation unit 110. Part of the incident light may be incident on the side surface of the opening 250 without being incident on the photoelectric transformation unit 110. This light may be incident on the barrier layer 264 and become refracted or reflected onto the photoelectric transformation unit 110, instead of onto adjacent cells causing crosstalk. For example, when light passes through different media, part of the light may be reflected from the boundary surface between the media and the remaining light may penetrate through the media. When light passes through first and second media, part of light may be reflected from the boundary surface between the first and second media, and the remaining light may penetrates through the first medium into the second medium. The relationship between the refractive indices of the first and second media and the reflexibility of light on the boundary surface between the first and second media may be given by the following equation: Reflexibility=((n₁−n₂)/(n₁+n₂))², where n₁ is the refractive index of the first medium, and n₂ is the refractive index of the second medium. As shown in the equation, the reflexibility of light on the boundary surface between the first and second media may increase as the difference between the refractive indices of the first and second media increases.

When, for example, the light transmission unit 270 is made of thermosetting resin, the refractive index thereof is at or about 1.55. When the barrier layer 264 is made of silicon nitride (SiN), the refractive index of SiN is at or about 2.0. Given these materials, when light is incident on the barrier layer 264 from the light transmission unit 270, the difference between the refractive indices of the light transmission unit 270 and the barrier layer 264 is large so that a large amount of light may be reflected from the boundary surface between the light transmission unit 270 and the barrier layer 264.

In contrast, when the barrier layer 264 is not formed on the side surface of the opening 250, the amount of light reflected from the boundary surface between the light transmission unit 270 and the barrier layer 264 may decrease. When the light transmission unit 270 is made of thermosetting resin, the refractive index thereof may be about 1.55. When the inter-metal insulating layer 230 is an oxide layer, the refractive index thereof may be about 1.43. If light is incident on the inter-metal insulating layer 230 from the light transmission unit 270, there may be little difference between the refractive indices. Accordingly, almost all light may penetrate through the light transmission unit 270 into the inter-metal insulating layer 230. That is, all light incident on the side surface of the opening 250 may cause crosstalk.

Accordingly, as in example embodiments, if the barrier layer 264 is provided on the side surface of the opening 250, the amount of light incident on an adjacent unit pixel, without being incident on a target unit pixel, may be reduced, thus decreasing pixel crosstalk. As a result, an image sensor having improved image reproduction characteristics may be fabricated.

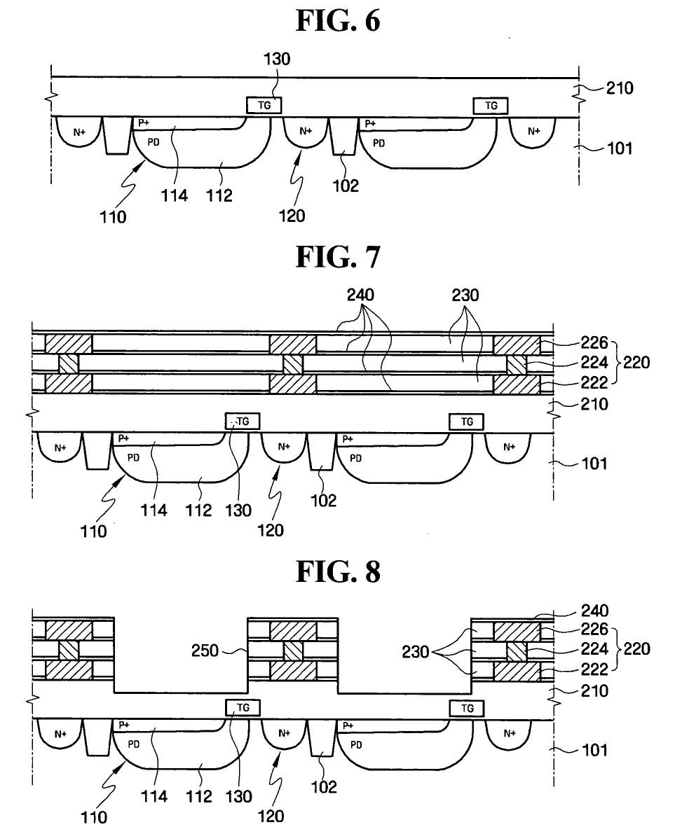

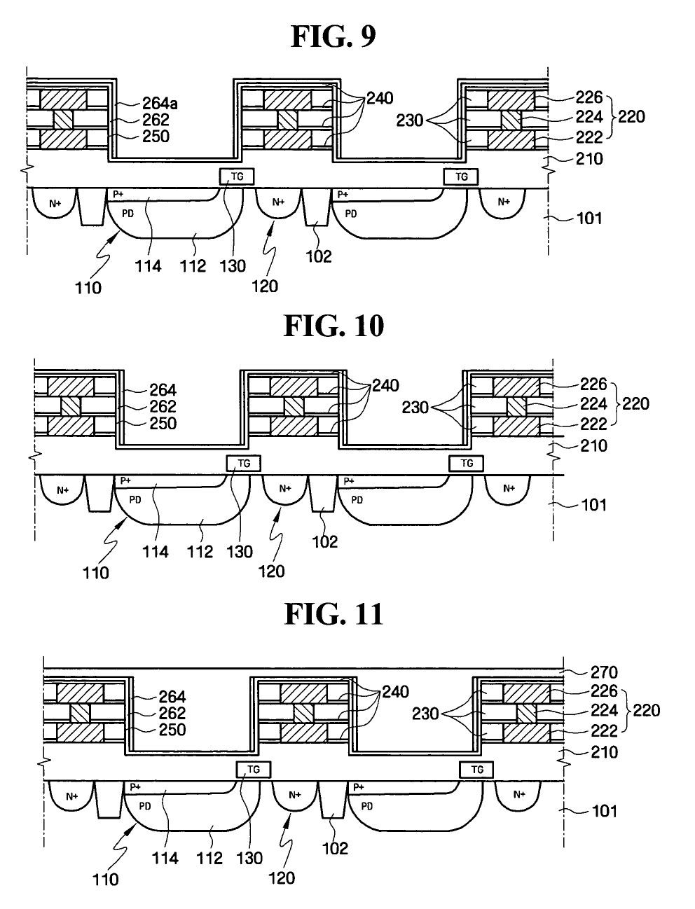

As shown in FIGS. 5 to 11, a method of fabricating an image sensor according to example embodiments of the present invention is described. FIG. 5 is a flowchart of an example method of fabricating an image sensor according to an example embodiment of the present invention. FIGS. 6 to 11 are sectional views showing an example method of fabricating an image sensor according to example embodiments.

As shown in FIGS. 5 and 6, the photoelectric transformation unit 110 and the interlayer insulating layer 210 may be formed on the semiconductor substrate 101 at S10. The device isolation region 102 may be formed on the semiconductor substrate 101 to define an active region (not shown). Impurities may be injected into the active region (not shown) through ion injection to form the photoelectric transformation unit 110 including the photodiode 112 and the pinning layer 114, and/or to form transistors corresponding to the charge detection unit 120, the charge transfer unit 130, the reset unit 140 (refer to FIG. 2), the amplification unit 150 (refer to FIG. 2), and/or the selection unit 160 (refer to FIG. 2). Thereafter, the interlayer insulating layer 210 may be formed to cover the semiconductor substrate 101 and to fill the empty space in which no transistors are present.

As shown in FIGS. 5 and 7, structure 215, in which the inter-metal insulating layers 230 and the metallic wire 220 are stacked in an alternating sequence, may be formed on the interlayer insulating layer 210 at S20. In example embodiments, the etching stopper films 240 may be formed between the plurality of inter-metal insulating layers 230. If the metallic wire 220 is a multi-layer structure, the space between the upper metallic wire 226 and the lower metallic wire 222 may be filled with the inter-metal insulating layer 230. The hole 224 may be formed to connect the upper metallic wire 226 to the lower metallic wire 222.

As shown in FIGS. 5 and 8, the opening 250 may be formed above the photoelectric transformation unit 110 at S30. A photoresist pattern may be formed on the photoelectric transformation unit 110. The opening 250 may be formed using a photoresist pattern as an etching mask. Etching may be performed so that all inter-metal insulating layers 230 and etching stopper films 240 are etched, and part of the interlayer insulating layer 210 may be etched. The depth of etching may be adjusted to prevent or reduce the transistors below the interlayer insulating layer 210 from being damaged. The opening 250 may be spaced apart from the metallic wire 220 by a predetermined or desired distance and formed to extend into the interlayer insulating layer 210 through the inter-metal insulating layer 230.

As shown in FIGS. 5 and 9, the oxide layer 262 and a barrier layer 264a may be formed on any surfaces of the opening 250, and on the top surface of structure 215 at S40.

The oxide layer 262 and the barrier layer 264a may be formed using, for example, Chemical Vapor Deposition (CVD) or any other suitable method. If the width of the opening 250 is about 1000 to 2000 nm, the oxide layer may be formed to a width of about 100 to 200 nm, and the barrier layer 264a may be formed to a width of about 50 to 100 nm.

As shown in FIGS. 5 and 10, the barrier layer 264a, (refer to FIG. 8), formed on the surface of the opening 250 and the top surface of structure 215 may be removed so that the barrier layer 264 remains only on the side surfaces of the opening 250 and not on the top of structure 215 at S50. An etch-back process may be used to remove the excess portions of barrier layer 264a, formed on the bottom surface of the opening 250 and the top surface of the structure. If the etch-back process is executed on the entire surface of the semiconductor substrate 101, the barrier layer 264 may remain on the side surfaces of the opening 250, and the excess sections of barrier layer 264a, formed on the bottom surface of the opening 250 and the top surface of the structure 215, is removed. The oxide layer 262 below the barrier layer 264a may protect the interlayer insulating layer 210 and the transistors that are formed below the oxide layer 262 and prevents or reduces damage thereto.

As shown in FIGS. 5 and 11, the light transmission unit 270 may fill the opening 250 at S60. The light transmission unit 270 may fill the opening 250 and cover the top of structure 215. Light transmission unit 270 may be of a thickness suitable to ensure that the surface above the opening 250 and structure 215 are planarized. The light transmission unit 270 may be made of a transparent and light-permeable material, for example, thermosetting resin or the like. If the light transmission unit 270 is made of thermosetting resin, the opening 250 may be filled with thermosetting resin using a spin-on coating method or any other acceptable method, and the thermosetting resin may be heated and hardened.

As shown in FIGS. 4 and 5, the color filter 280 and the micro-lens 290 may be formed on the light transmission unit 270 at S70.

The color filter 280 may be formed on the light transmission unit 270. The color filter 280 may be formed in such a way to arrange red, green and blue color filters in a Bayer type arrangement or any other type of arrangement. The planarizing layer 282 may be formed on the color filter 280. The planarizing layer 282 may be formed to planarize a top surface of the color filter 280, and may be made of, for example, thermosetting resin or the like. Thermosetting resin or a similarly-suitable material may be formed through a spin-on coating method or another acceptable method, and may be heated and hardened, so that the planarzing layer 282 may be formed. Then, the micro-lens 290 may be formed on a portion of the planarizing layer 282 corresponding to the photoelectric transformation unit 110.

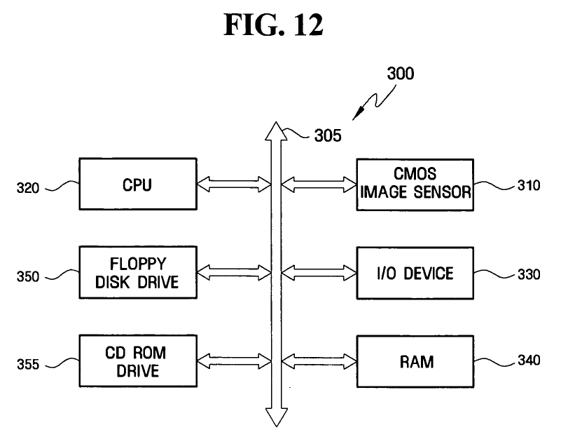

FIG. 12 is a schematic diagram showing a process-based system including an image sensor according to example embodiments.

As shown in FIG. 12, a processor-based system 300 may be a system for processing an output image of a CMOS, or similarly-suitable type, image sensor 310. The system 300 may be, for example, a computer system, a camera system, a scanner, a mechanized clock system, a navigation system, a video phone, a supervisor system, an auto-focus system, a tracking system, an operation monitoring system, an image stabilization system, etc., but a system is not limited to the above examples.

The processor-based system 300, such as a computer system, may include a Central Processing Unit (CPU) 320, for example, a microprocessor capable of communicating with an input/output (I/O) device 330 through a bus 305. The image sensor 310 may communicate with a system through the bus 305 or other communication links. The processor-based system 300 may further include Random Access Memory (RAM) 340, a floppy disk drive 350 and/or a Compact Disk Read Only Memory (CD ROM) drive 355, and/or a port 360 that may communicate with the CPU 320 through the bus 305. The port 360 may couple a video card, a sound card, a memory card and/or a Universal Serial Bus (USB) device to a CPU, or may perform data communication with other systems. The image sensor 310 may be integrated with a CPU, a Digital Signal Processor (DSP), or a microprocessor. The image sensor 310 may be integrated with memory and/or integrated into a chip separate from a processor.

As described, example embodiments provide an image sensor and method of fabricating an image sensor, which have the following one or more advantages, namely:

pixel crosstalk, occurring when light is incident on an adjacent pixel, rather than a desired target pixel, may be reduced, and/or

a semiconductor integrated circuit device having improved image reproduction characteristics may be fabricated.

Although example embodiments have been disclosed for illustrative purposes, those skilled in the art will appreciate that various modifications, additions and substitutions are possible, without departing from the scope and spirit of the disclosure in the accompanying claims. Therefore, it should be understood that the above embodiments are only examples and are not limiting.

What is claimed is:

1. An image sensor comprising:
a photoelectric transformation unit, with an opening above the photoelectric transformation unit; and
a barrier layer on the sides of the opening.

2. The image sensor of claim 1, further comprising:
a semiconductor substrate;
an interlayer insulating layer covering the semiconductor substrate; and
a structure of alternately-stacked metallic wires and inter-metal insulating material on the interlayer insulating layer.

3. The image sensor of claim 2, wherein the photoelectric transformation unit is on the semiconductor substrate.

4. The image sensor of claim 2 wherein the opening above the photoelectric transformation unit is spaced apart from the metallic wire and extends into the interlayer insulating layer through the inter-metal insulating layer.

5. The image sensor of claim 1, further comprising:
a light transmission unit filling the opening;
a color filter on the light transmission unit; and
a micro-lens on the color filter.

6. The image sensor of claim 1, wherein the barrier layer is formed of a material having a refractive index greater than that of the light transmission unit.

7. The image sensor of claim 6, wherein the barrier layer is made of a material having a refractive index greater than that of the light transmission unit by 0.3 or more.

8. The image sensor of claim 1, wherein the barrier layer is made of silicon nitride (SiN).

9. The image sensor of claim 1, further comprising:
an oxide layer on sides of the opening and on the top of the alternately-stacked metallic wire and inter-metal insulator structure.

10. The image sensor of claim 1, wherein the light transmission unit is made of thermosetting resin.

11. The image sensor of claim 1, further comprising:
a planarizing layer between the light transmission unit and the color filter.

12. A method of fabricating an image sensor, the method comprising:
forming a photoelectric transformation unit in a semiconductor substrate;
forming an interlayer insulating layer to cover the semiconductor substrate;
forming a structure of alternately-stacked metallic wires and inter-metal insulating material on the interlayer insulating layer;
forming an opening above the photoelectric transformation unit apart from the metallic wiring and extending into the interlayer insulating layer through the inter-metal insulating layer;
forming a barrier layer on the sides of the opening;
forming a light transmission unit to fill the opening;
forming a color filter on the light transmission unit; and
forming a micro-lens on the color filter.

13. The method of claim 12, wherein the barrier layer is made of a material having a refractive index greater than that of the light transmission unit.

14. The method of claim 13, wherein the barrier layer is made of a material having a refractive index greater than that of the light transmission unit by 0.3 or more.

15. The method of claim 12, wherein the barrier layer is made of silicon nitride (SiN).

16. The method of claim 12, wherein forming the barrier layer further includes forming a barrier layer on a bottom and a sides of the opening and on the top of the structure of alternately-stacked metallic wires and inter-metal insulating material; the method further comprising:
removing the barrier layer formed on the bottom of the opening and on the top of the structure of alternately-stacked metallic wires and inter-metal insulating material.

17. The image sensor fabrication method of claim 16, further comprising:
forming an oxide layer on the bottom and the sides of the opening and the on top of the structure before forming the barrier layer on the bottom and sides of the opening and on the top of the structure.

18. The method of claim 16, wherein removing the barrier layer is performed using an etch-back process.

19. The method of claim 12, wherein the light transmission unit is made of thermosetting resin.

20. The method of claim 12, further comprising:
forming a planarizing layer between the light transmission unit and the color filter.
